(19) United States
(12) Patent Application Publication
(10) Pub. No.: US 2018/0329801 A1
(43) Pub. Date: Nov. 15, 2018

(54) DETECTING AND CORRECTING LAYOUT ANOMALIES IN REAL-TIME

(71) Applicant: Microsoft Technology Licensing, LLC, Redmond, WA (US)

(72) Inventors: Timothy Page MCKEE, Seattle, WA (US); Sarvesh NAGPAL, Issaquah, WA (US); Narendra RANA, Sammamish, WA (US); Toby Hamilton WALKER, Newton, MA (US)

(73) Assignee: Microsoft Technology Licensing, LLC, Redmond, WA (US)

(21) Appl. No.: 15/636,892

(22) Filed: Jun. 29, 2017

Related U.S. Application Data
(60) Provisional application No. 62/506,274, filed on May 15, 2017.

(51) Int. Cl. G06F 11/36; G06N 99/00; G06F 17/21

(52) U.S. Cl. CPC G06F 11/3624; G06F 17/30873; G06F 17/212; G06N 99/005

(57) ABSTRACT

Systems and methods are provided that automatically detect and correct website and application layout anomalies to improve the overall user experience. The detection and correction system may leverage at least one algorithm that is trained using a dataset. The dataset may be a compilation of webpage and application layouts associated with various combinations of devices, hardware, and software components. Each detected layout anomaly and corresponding corrective action, along with associated operating environment characteristics, may be used to augment the dataset to improve the efficiency and effectiveness of the detection and correction system. In this way, a consistent and positive user experience across website versions, application versions, device types, etc., may be delivered to users.

### RELATED APPLICATIONS

This application claims the benefit of U.S. Provisional Application Ser. No. 62/506,274, entitled “DETECTING AND CORRECTING LAYOUT ANOMALIES IN REAL-TIME,” filed on May 15, 2017, the entire disclosure of which is hereby incorporated herein by reference.

### BACKGROUND

A positive user experience on a website or application is imperative to the overall success of that website or application. It is truly a make-or-break aspect of effective digital marketing to foster and maintain positive consumer perception. User experience (UX) refers to a person's perception or attitude when interacting with a digital product, usually on a device interface. UX encompasses numerous factors—some that are controllable by designers and developers and some that are environmental or dictated by user preference. These factors include usability, accessibility, performance, design/aesthetics, utility, ergonomics, overall human interaction, and marketing. In terms of consumer loyalty, user experience is just as important as an application's visual identity and brand recognition. It does not matter what a site or an application may look like if people are unable to interact with it. Moreover, to maintain consumer loyalty, users of a website or application need to continue to enjoy their interactions.

While UX is important for any digital product, it may be even more important for certain types of digital products: complex sites or applications, retail or online sales, start-up and small business sites, small-budget projects, and projects or sites that are heavily trafficked and expected to be a dependable resource to users, such as search engines. In fact, in addition to reliable search results, users expect and have come to demand UX features such as trouble-free navigation, intuitive interface design and functionality, and an esthetically pleasing display from search engines. Otherwise, users will simply not return to the website. Not only do consumers demand the affirmative features identified above, but a negative user experience caused by frequent display errors and page faults will quickly undermine consumer retention

It is with respect to these and other general considerations that example aspects, systems, and methods have been described. Also, although relatively specific problems have been discussed, it should be understood that the examples should not be limited to solving the specific problems identified in the background.

### SUMMARY

Developing interaction-rich websites and applications drives users back to those websites and applications, ultimately creating successful digital products. Moreover, a system that automatically detects and corrects website and application layout anomalies further improves the overall user experience. An effective UX is characterized by consistent implementation across a variety of hardware and software combinations, including, but not limited to, device screen resolutions, operating systems, browser types, individual user preferences, and software versions. A successful digital product employs a common user experience across the website version, the application version, the desktop version, the mobile version, etc., of the digital product. Furthermore, a successful digital product employs a common user experience regardless of the user interface language (e.g., right-to-left or left-to-right written languages), the market format (e.g., date format and currency format), operating system types, operating system versions, browser types, browser versions, etc. of the digital product. Such an effective and consistent UX removes unpredictability and user frustration and therefore, potential problems with the UX.

In aspects, a processor-implemented method of correcting layout anomalies is provided. The method includes detecting at least one operating environment characteristic of a computing device and detecting at least one layout anomaly on a display interface of the computing device. The method further includes characterizing the at least one layout anomaly and determining at least one corrective action corresponding to the at least one layout anomaly. Additionally, the method includes automatically applying the at least one corrective action corresponding to the at least one layout anomaly and updating a database with the at least one operating environment characteristic, the at least one layout anomaly, and the at least one corrective action.

In further aspects, a computing device is provided. The computing device includes at least one processing unit and at least one memory storing processor-executable instructions that when executed by the at least one processing unit cause the computing device to perform one or more operations. The operations include detecting at least one operating environment characteristic of the computing device and detecting at least one layout anomaly on a display interface of the computing device. The operations further include characterizing the at least one layout anomaly based at least in part on a previous layout anomaly and determining at least one corrective action corresponding to the at least one layout anomaly. Additionally, the operations include automatically applying the at least one corrective action corresponding to the at least one layout anomaly and updating a database with the at least one operating environment characteristic, the at least one layout anomaly, and the at least one corrective action.

In still further aspects, a processor-readable storage medium storing instructions that when executed by one or more processors of a computing device perform a method of correcting layout anomalies. The method includes detecting at least one operating environment characteristic of the computing device and detecting at least one layout anomaly on a display interface of the computing device. The method further includes characterizing the at least one layout anomaly based at least in part on a previous layout anomaly and determining at least one corrective action corresponding to the at least one layout anomaly. Additionally, the method includes automatically applying the at least one corrective action corresponding to the at least one layout anomaly and updating a database with the at least one operating environment characteristic, the at least one layout anomaly, and the at least one corrective action.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates an example of a distributed system for receiving and storing data related to correcting layout anomalies in real-time.

FIG. 2 is a block diagram illustrating a method for detecting and correcting layout anomalies in real-time.

FIG. 3A illustrates an example of a broken webpage with layout anomalies.

FIG. 3B illustrates an example of a corrected webpage.

FIG. 4A illustrates an example of a mobile webpage with layout anomalies.

FIG. 4B illustrates an example of a corrected mobile webpage.

FIG. 5 illustrates an example of a webpage with layout anomalies caused by a third-party application or extension.

FIG. 6 is a block diagram illustrating example physical components of a computing device with which aspects of the disclosure may be practiced.

FIGS. 7A and 7B are simplified block diagrams of a mobile computing device with which aspects of the present disclosure may be practiced.

FIG. 8 is a simplified block diagram of a distributed computing system in which aspects of the present disclosure may be practiced.

FIG. 9 illustrates a tablet computing device for executing one or more aspects of the present disclosure.

### DETAILED DESCRIPTION

In the following detailed description, reference is made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

Often times, developers and designers neglect to account for the various screen resolutions, operating systems, web browsers, devices, and individual user preferences that may be factored into how a website or application displays on a device interface. As a result of this neglect, a web page may look different on different computers, and in many cases, the different appearances may be rife with display errors and page faults. Even if developers and designers account for the potential pitfalls above, rendering and other errors can still occur. In some cases, new features or software updates can cause incompatibility issues. For instance, a “flight” may refer to a new feature or experience delivered to consumers for testing. Accordingly, one set of users may receive a default experience and another set of users may receive the new experience. Hundreds of flights may be delivered at any given time, some of which may interact poorly to yield unwanted display results. The permutations of these flights approach infinity, as a set of one million flights, for example, yields one million factorial different permutations (i.e., a number with over 5.6 million digits). Due to the vast number of permutations, many flight interactions will continue to be new and previously unseen when the system disclosed herein analyzes the data of these new interactions for layout anomalies and subsequent corrective actions. Such errors and faults are primary factors leading to customer dissatisfaction.

Previously, solutions to these broken and error-ridden webpage and application displays involved manually testing the webpages and applications for incompatibilities among certain hardware and software. That is, most systems cannot detect these unwanted display errors in real-time. Furthermore, they cannot automatically detect subtle, nuanced formatting issues, only extreme failures. The absence of automatic detection and correction of layout anomalies leads to poor user experiences, ultimately creating a negative emotional connection to the website or application for the users. As a result, training and support costs, development time and costs, maintenance costs, unproductivity, and customer dissatisfaction (e.g., abandoning a product for a competing product) all increase. Without an effective UX, digital products are likely to fail.

As detailed above, the disclosure generally relates to a system and methods for detecting and correcting webpage and application layout anomalies in real-time. The webpages and applications disclosed herein may be run and displayed on a variety of different devices with various hardware and software configurations. These devices may include, among others, a desktop computer, laptop computer, mobile phone, tablet, head-mounted display, and wearable device (e.g., smart watch), etc. In some examples, a layout anomaly may refer to an unexpected device characteristic, such as an unrecognized web element or web browser. In aspects, an element or browser that is “unrecognized” is one for which layout data has not previously been collected. In other examples, a layout anomaly may refer to an improperly displayed font or an overlapping image. In yet other examples, a layout anomaly may result from a third-party application or extension that obscures content expected to be displayed on a webpage or application. In other examples, the third-party application or extension may inject new and/or unexpected content into the webpage or application. The detection of a layout anomaly may begin with compiling a dataset. Such data gathering may be used to create machine-learning algorithms for automatically detecting layout anomalies across a variety of different operating environments and taking immediate corrective action on such layout anomalies. For instance, after gathering enough data so as to create a comprehensive database of recognized device operating environments and proper webpage/application layouts, then the system of detecting and correcting subsequent layout anomalies may be automatically implemented.

The detection and correction system disclosed herein may begin with leveraging at least one machine-learning algorithm that is trained using a dataset. The dataset that is used to train these algorithms may be a compilation of webpage and application layouts associated with various combinations of devices, hardware, and software components. For example, some of the layouts in the training dataset may be associated with an iPhone 6 running iOS version 9.0 and accessing webpages through the Safari Internet browser. In other examples, some of the layouts in the training dataset may be associated with a Dell laptop computer equipped with an Intel® Celeron® Processor N3060 running Windows 10 Pro operating system and accessing webpages through the Chrome® Internet browser running version 57.0.02987.133. As should be appreciated, the dataset may include layout data for any number of hardware and software configurations running a variety of websites or applications.

In some cases, layout data gathered from multiple devices of the same device type with the same operating system and the same website or application may be compared for consistency. In some cases, a majority of the layouts may exhibit the same or substantially the same behavior within the same environment, whereas a certain minority of the layouts may exhibit a different behavior. In aspects, those layouts exhibiting the same or substantially the same behavior may be identified as “correct” or “non-defective” layouts within the dataset, while layouts exhibiting different behavior may be identified as “anomalies” within the dataset. Anomalies within the dataset may further be characterized based on an anomaly type, e.g., failure to render, incomplete render, overlapping rendering, misplaced rendering, third-party interference, etc. Depending on the web element or elements associated with the anomaly, a different corrective action may be appropriate. In some cases, e.g., where a non-essential element is associated with the anomaly, downgrading the display to eliminate the non-essential element may resolve the issue; in other cases, e.g., where an essential element is associated with the anomaly, corrective action may involve hiding or moving a different element, refreshing the page, etc. As the detection and correction system disclosed herein continues to detect anomalies, characterize anomalies, and identify corrective actions for the anomalies, the trained dataset will continue to grow. As the trained dataset grows, the at least one machine-learning algorithm using the trained dataset will become more accurate and precise. Additionally, the system may be able to handle more outlier cases as the datasets grow with a variety of anomalies. For example, the machine-learning algorithms of the detection and correction system may also detect new patterns as they arise. Specifically, a new browser may be launched, and the machine-learning algorithm may be able to detect and analyze the new browser, detect layout anomalies, and report those anomalies associated with the new browser back to developers for manual analysis.

The disclosed system of detecting and correcting layout anomalies improves technological systems in numerous ways. For example, the disclosed system may be able to detect and correct thousands more layout anomalies automatically than a human could detect and correct manually. Such efficiencies may conserve electronic resources, like battery power, on the device side; and processing, memory and network resources on both the webpage/application provider side and the device side. Furthermore, utilizing a distributed system to complete these detections and corrections may allow memory to be more uniformly distributed across devices involved in the system, ultimately resulting in faster processing speeds and a more dynamic allocation of memory. Automatically making layout anomaly corrections in real-time also reduces the demand for customer service resources. An immediate detection and correction system, like the system disclosed herein, results in higher customer satisfaction with particular websites and/or applications.

Additionally, due to the automated nature of the disclosed system of detecting and correcting layout anomalies, the system becomes increasingly more accurate in terms of both detection and correction. This is due to the system automatically storing the detected layout anomalies and the subsequent corrective action(s) within the dataset. In this way, the system may increasingly automate and refine its responses to future anomalies by relying on a growing database of saved anomalies and corresponding solutions. As the dataset continues to grow, the machine learning components may continue to become more and more precise. In sum, more accuracy and precision in detecting and correcting layout anomalies results in more efficient use of device resources, network resources and system memory, allowing for faster processing speeds and an overall more enjoyable UX.

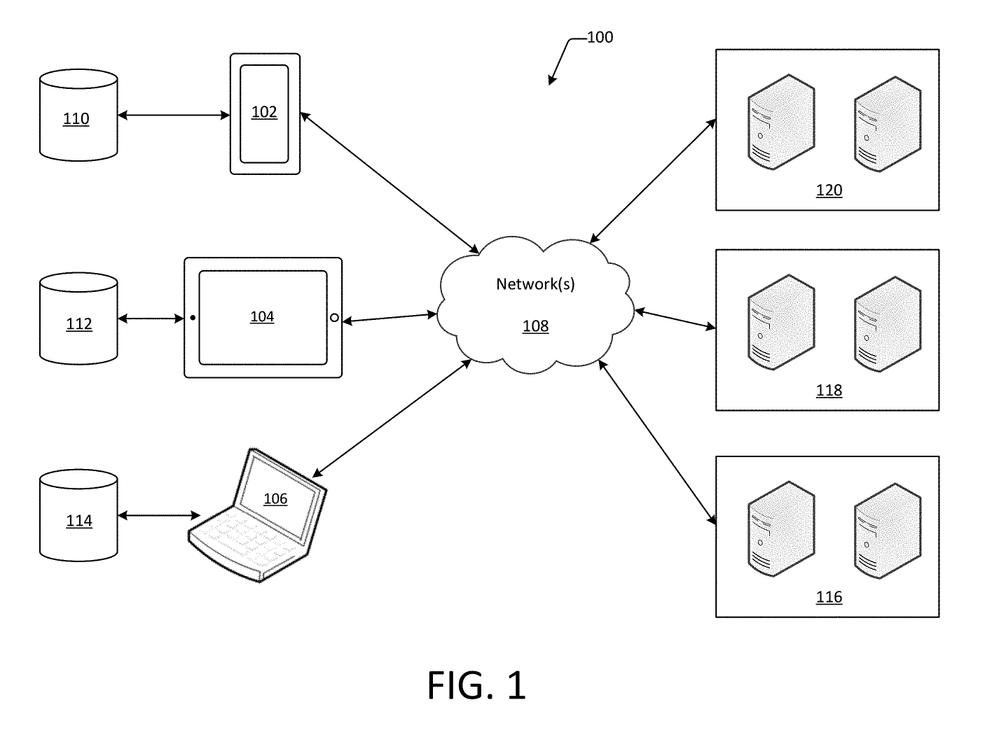

FIG. 1 illustrates an example of a distributed system for receiving and storing data related to detecting and correcting layout anomalies in real time. A system that facilitates the real-time detection of layout anomalies within a webpage and/or an application and automatically takes corrective action to repair the layout anomaly in real-time may be run on an electronic device including, but not limited to, client devices such as a mobile phone 102, a tablet 104, and a personal computer 106. The disclosed system may receive device data related to a state of a webpage or an application. The device data may be comprised of both various operating environment specifications, user preferences or settings, and layout data related to how elements on the webpage/application are displayed. For instance, the device data may be dynamically transmitted as the state of the webpage or application changes. In order to detect a layout anomaly on a webpage/application, the system may first process the device data (i.e., operating environment and webpage/application display data). During processing of the device data, the electronic device may utilize local data stored in a local database, remote database stored on servers 116, 118, and 120, or a combination of both.

For example, mobile phone 102 may utilize local database 110 and access servers 116, 118, and/or 120 via network(s) 108 to process the device data in order to detect a perceived layout anomaly. In other example aspects, tablet 104 may utilize local database 112 and network(s) 108 to synchronize a detected layout anomaly and a subsequent corrective response across client devices of the same device type (e.g., having substantially the same hardware and software specifications, user settings, etc.) and across all servers running the detection and correction system. For example, if the initial input is received on tablet 104, the device data and subsequent detection and corrective response generation may be saved locally in database 112, but also shared with servers 116, 118, and/or 120 via the network(s) 108.

In other example aspects, the detection and correction system may be employed locally. For instance, if the system servers 116, 118, and 120 are down, the detection and correction system may still operate on a client device, such as mobile device 102, tablet 104, and computer 106. In this case, a subset of the trained dataset applicable to the client device type and at least a client version of the machine-learning algorithm may be locally cached so as to automatically respond to layout anomalies detected on the client device. The system servers 116, 118, and 120 may be down for a variety of reasons, including but not limited to, power outages, network failures, operating system failures, program failures, misconfigurations, and hardware deterioration.

As should be appreciated, the various methods, devices, components, etc., described with respect to FIG. 1 are not intended to limit systems 100 to being performed by the particular components described. Accordingly, additional topology configurations may be used to practice the methods and systems herein and/or components described may be excluded without departing from the methods and systems disclosed herein.

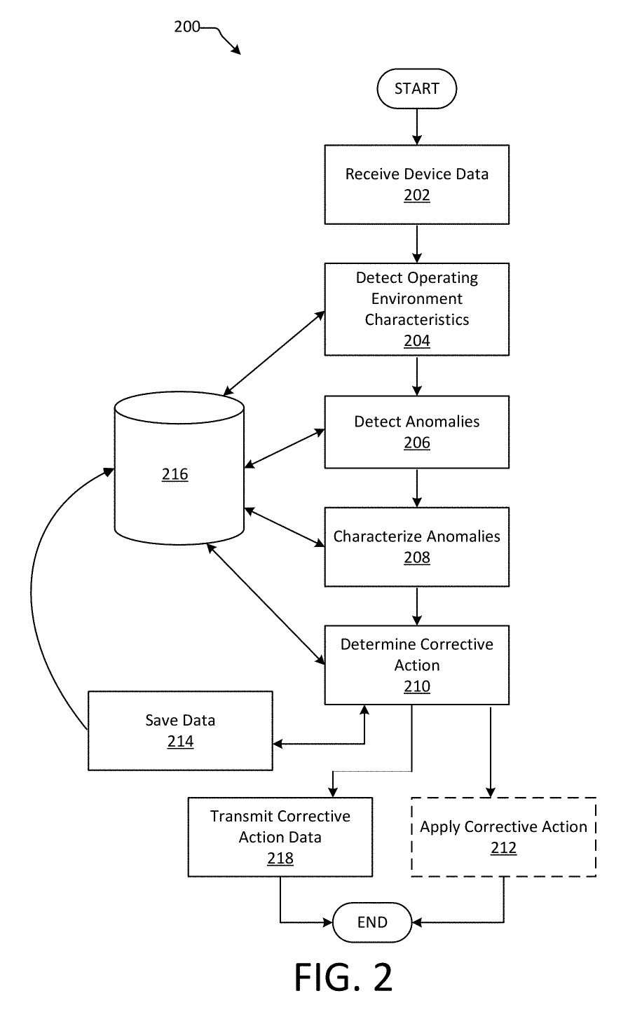

FIG. 2 is a block diagram illustrating a method for detecting and correcting layout anomalies in real-time.

System 200 begins with receive device data operation 202. The device data may include, but is not limited to, device features, operating environment characteristics, user preferences or settings, webpage and/or application identification data, and layout data. The device features and operating environment characteristics may be transmitted to the system for analysis. Device features may include, but are not limited to, hardware specifications such as dimensions, weight, CPU, GPU, RAM, storage, memory cards, display, resolution, battery, operating system, camera, SIM card, Wi-Fi, USB capability, Bluetooth capability, sensors, etc. Operating environment characteristics may include software specification for use with the particular device type and hardware configuration, such as operating system and version, installed applications, third-party services, etc. Additionally, the operating environment characteristics may include, but are not limited to, network download and upload speeds, Internet browser type, Internet browser version, and third-party extensions and applications that are running simultaneously within the operating environment. System 200 may receive all of or a portion of the aforementioned information related to a device and operating environment at receive device data operation 202.

At detect operating environment characteristics operation 204, the system may then analyze the device data and extract the pertinent information related to the operating environment. As previously mentioned, the operating environment characteristics may include, but are not limited to, device display and resolution, dimensions, CPU, GPU, operating system, operating system version, Internet browser type, Internet browser version, RAM, storage, memory card types, Bluetooth capabilities, Wi-Fi capabilities, network upload and download speed, any third-party extensions/applications running simultaneously within the operating environment, and the like. In some cases, the operating environment characteristics may be compared against a dataset stored in database 216. For example, if system 200 extracts information related to an unrecognized Internet browser, then system 200 may flag the unrecognized Internet browser as an anomaly after cross-checking that information regarding Internet browser is not available within database 216. More generally, if an operating environment characteristic does not appear in database 216, then that unrecognized characteristic may be flagged as an anomaly.

At detect anomalies operation 206, system 200 may detect the anomalies associated with a layout of at least one webpage or application that is running on the device. Layout anomalies may include, but are not limited to, incomplete or improper image rendering; misplaced images, web elements or graphics; overlapping images, web elements or graphics; third-party ad-blockers that hide content; third-party applications/extensions that inject third-party content obscuring web elements and content on the webpage, etc.

Layout anomalies may be detected by any suitable means, such as evaluating pixels of the display surface for inconsistencies, evaluating the dimensions of the display surface in light of predetermined constraint rules, evaluating the placement of various images, web elements and graphics for proper placement on the display surface, evaluating the distance of elements from the edge of a browser display, evaluating the distance between and among various elements displayed on a webpage, assessing the existence of potential scripting (e.g., JavaScript®) errors, checking for multiple definitions of the same element in sources, examining potential conflicts in style sheets (e.g., CSS), determining the presence of unexpected elements or modified elements (e.g., ads injected into the webpage and/or application), determining that detected properties of a known element do not match expected properties of that known element (e.g., location of origin for ads), hashing/signing page elements to locate an undetected element, etc. For example, a layout anomaly may be detected on a Bing® search engine webpage. For example, the anomaly may include an out-of-place image, web element or graphic, such as the Bing® sign-in logo. In order to check if there is an out-of-place image on the Bing® search engine page, the system 200 may reference database 216, which may house a dataset of correct layouts associated with certain hardware and software configurations. For example, the dataset may indicate that for correct display, the Bing® sign-in logo should be located at a certain X-Y coordinate in the top right portion of the displayed webpage. If system 200 determines at operation 206 that on the webpage currently under observation that the Bing® sign-in logo is not at the correct X-Y coordinate in the top right portion of the displayed webpage, the system may flag this inconsistency as an anomaly.

In other example aspects, the detect anomalies operation 206 may detect two overlapping images on the webpage. System 200 may reference database 216 with a dataset of correct layout configurations to determine at operation 206 that the current webpage under observation contains an overlapping-image anomaly. Furthermore, in some cases, the system 200 may determine that multiple anomalies exist on a single webpage. For example, a combination of overlapping images and out-of-place images may exist, causing the system to flag multiple aspects of the webpage for layout anomalies.

The detect anomalies operation 206 may also structurally compare the content (e.g., a content tree) and properties (e.g., positions, styles, etc.) of elements on a webpage or application to determine if the content and properties of the displayed element match the expected content and properties within a certain tolerance range. For example, displayed distance properties of an element may be compared with known distance properties using a distance function. The distance function may use spatial information (e.g., within pixel systems, etc.) to compare the displayed properties with known properties for the element. In other examples, the displayed properties of an element may be compared with known properties from a default layout. A default layout may be created by first testing certain elements in a controlled environment. The controlled environment may include a set of familiar devices, applications, browsers, hardware components, etc.

At characterize operation 208, system 200 may characterize the anomalies. Characterizing the anomalies may first involve referencing the previously extracted operating environment characteristics. By referring to the operating environment characteristics first, the dataset used to characterize the anomalies may be decreased in size, thereby decreasing subsequent processing time and resource usage. Once the proper operating environment filters are applied to database 216, a proper dataset may be retrieved for comparison with the current webpage or application under observation. The anomalies detected at operation 206 may then be compared with both past anomalies and proper layout configurations for the particular operating environment. Using both historical anomaly data and proper configuration data, system 200 may characterize the detected anomalies accurately and efficiently at operation 208.

For example, system 200 may detect an anomaly on a webpage at operation 206. After system 200 compares the detected anomaly with database 216, the results of that comparison may be used to characterize the anomaly at operation 208. If the detected anomaly is substantially similar to at least one anomaly of a pre-programmed set of anomalies, a set of previously detected anomalies, or a combination of both pre-programmed and previously detected sets of anomalies stored in database 216, then system 200 may characterize the detected anomaly by an anomaly type based on the at least one similar anomaly. Specifically, system 200 may determine that the detected anomaly is an image-overlapping type of anomaly based on a comparison with a dataset of stored image-overlapping anomalies and determining that the operating environment characteristics associated with at least one stored image-overlapping anomaly are substantially similar (e.g., consistent).

In some example aspects, the detected anomaly may be unexpected and unknown (e.g., unrecognized). As a result, the unknown anomaly may not be substantially similar to any prior or pre-programmed anomaly within the datasets stored in database 216. If system 200 determines that no stored datasets in database 216 are substantially similar to the detected anomaly currently under observation, then system 200 may characterize the unknown anomaly as a new anomaly in need of manual analysis. In some cases, determining that a manual analysis is appropriate may occur at determine corrective action operation 210. For instance, the corrective action in this example aspect may be to flag the unknown anomaly for manual analysis.

In addition to characterizing the type of the detected anomaly, system 200 may evaluate the one or more elements involved in the detected anomaly, e.g., elements including web controls or widgets, images, graphics, input fields, search results, etc. In some case, evaluating the one or more elements may involve determining a ranking of the one or more elements. The ranking may result in identifying some elements having a higher priority than other elements. For instance, the Bing® search bar may be a higher priority element than a color of a search control. In another instance, a sign-in feature may be overlapping with a Bing® search bar, and the search bar may take priority over the sign-in feature. Specifically, the sign-in function on that webpage may be disabled in order to allow a user to interact with the search bar, thereby maintaining a satisfactory overall user experience. In another instance, a search result may be poorly presented (e.g., jumbled text, discoloration) to the user. In order to maintain the overall user experience, the subsequent search results that are adequately presented may have a higher priority than the poorly presented search result. Specifically, even if the poorly presented result was germane to the query of the user, the most appropriate corrective action may be to remove that search result, so that the user may continue browsing among the other search results and continue having a positive experience with the webpage. In other instances, unexpected content may be removed or forced to match known properties. For example, a poorly presented search result may be reformatted to comply with known properties (e.g., based on data or pre-coded models of a correct state).

In other instances, the content provider may associate priorities with a certain application or webpage. The priority information from the content provider may be provided to system 200. For example, the “above-the-fold” elements (i.e., content that displays on a site or application without requiring the user to scroll) may receive a higher priority from a content provider than other elements on the webpage or application. In some example aspects, system 200 may honor the priority rankings from the content provider. In other example aspects, system 200 may determine that other elements displayed in a webpage or application should receive higher (or lower) priority rankings than the priority rankings provided by the content provider.

In yet other instances, priority may be established according to frequency of usage or overall visual prominence. For example, system 200 may be preprogrammed with historical data indicating that certain elements on a webpage or application are frequently clicked or viewed. These elements may receive a higher priority ranking according to the historical data.

At determine corrective action operation 210, system 200 may determine a corrective action for fixing the detected anomaly at operation 210. In order for system 200 to determine the appropriate corrective action to apply to the detected anomaly, system 200 may identify one or more corrective actions corresponding to the at least one anomaly matching the detected anomaly in database 216. Additionally, the one or more corrective actions may be evaluated based on the ranking of the one or more elements involved in the detected anomaly. For example, a frequently occurring anomaly may be an image-overlapping anomaly on a webpage. Corresponding corrective actions that may be applied to an image-overlapping anomaly on a webpage may involve moving one of the overlapped images, hiding one of the overlapped images, downgrading the website experience, etc.

As described above, the overlapped images involved in the detected anomaly may include priority ranking data. For instance, one image may have priority over another image because, for example, the higher prioritized image contains written content, whereas the lower-prioritized image does not. If the detected anomaly currently under observation is determined to be an image-overlapping anomaly, then a corrective action that may be applied to the detected anomaly may involve accessing the priority rankings of the two overlapping images and hiding the lower-ranked image. In other instances, e.g., where the overlapping images or elements erroneously displayed on a webpage or application do not have priority rankings, the corrective action may involve separating the images or elements from one another, refreshing the page, or similar action. However, where the webpage or application does not provide enough space for separating the images, then one of the images may be deleted according to its position (e.g., the image on the bottom may be deleted), according to a randomizer algorithm (e.g., a random bit of 0 or 1 decides which image is deleted), etc.

As should be appreciated, the type of corrective action applied in operation 210 may be different across various combinations of hardware and software, for different affected elements, etc., as detected and stored in operations 204 and 206. For example, if an image-overlapping anomaly occurs on a desktop computer with a large screen and high resolution specifications, the corrective action applied in operation 210 may be to simply separate the overlapping images because the large screen of the desktop computer may be large enough to accommodate the two separate images. Conversely, if the same image-overlapping anomaly was detected in operation 206, but the operating environment characteristics detected in operation 204 indicated that the device was a mobile phone and not a desktop computer, then the corrective action that may be applied in operation 210 may be different. For example, due to the smaller screen dimensions and lower resolution, the corrective action that may be applied may be to delete or hide one of the images altogether. As previously mentioned, the removal of one of the overlapping images may be determined according to priority, position, or chance, among other algorithms.

In yet further examples, multiple corrective actions may be applied at operation 210. For example, if a third-party extension on a web browser causes a third-party advertisement pop-up to obscure content on a webpage, the first corrective action may be to move the pop-up advertisement to a different location on the webpage. Following the repositioning of the third-party ad, system 200 may determine that the pop-up advertisement resulted in anomalies associated with other elements. In this case, the system 200 may then apply a second corrective action in response to the other resulting anomalies. In other example aspects, system 200 may initially determine that the third-party advertisement is an unwanted third-party advertisement, and a first corrective action may be to delete the advertisement rather than repositioning it.

In another example aspect, system 200 may analyze third-party advertisements and third-party extensions through a revenue lens. Specifically, system 200 may consider the revenue impact of a third-party extension or application that obscures content on a webpage that is generating revenue. For example, if a third-party pop-up covered an underlying advertisement on the webpage, the number of clicks or views on the underlying advertisement may inevitably decrease, therefore resulting in a decrease in revenue. Furthermore, some webpages implement an algorithm that matches displayed advertisements with the search query. If a random third-party advertisement pops up on the webpage, the user experience may decrease and may inevitably cause a user to navigate away from the webpage. A decrease in user experience may lead to a loss in overall users, which may lead to a loss in overall revenue.

In other instances, system 200 may take a variety of corrective actions to repair and remove the detected anomaly. For example, system 200 may take a corrective action that downgrades a webpage's displayed graphics or decreases the number or variety of “flights” that are being transmitted to groups of users. Specifically, certain “flights” may be prevented from running. In other examples, system 200 may stop transmitting “flights” altogether until a certain type of anomaly is resolved.

After the appropriate corrective action or actions are determined by system 200 in operation 210, the detected anomaly and corresponding corrective action(s) may be saved at operation 214 and transmitted back to database 216. In aspects, the saved data may be organized within database 216 according to the operating environment characteristics that were detected and the one or more elements involved in the detected anomaly. That is, the corrective action(s), detected anomaly, operating environment characteristics, elements involved, comparison data between the detected anomaly and previously stored anomalies, and any other pertinent data may be saved at the save data operation 214. All of the saved data at operation 214 may be transmitted back to database 216, further expanding the dataset that system 200 uses to automatically detect anomalies and apply appropriate corrective actions to address the detected anomalies.

After the appropriate corrective action is determined at operation 210, the data collected from the machine-learning algorithms throughout the previous steps may be aggregated, organized, and transmitted for manual review at operation 218. The information that the machine-learning algorithms acquire may include detailed and organized information regarding layout anomalies across a plethora of webpages. Such rapid acquisition of this information, coupled with the rapid aggregation and organization of this information, may be executed by multiple machines with high levels of processing power. Nuanced layout anomalies only detectable to a machine-learning algorithm analyzing billions of webpages may be captured, formatted, and transmitted for manual review. For example, the nuanced anomalies that may be transmitted back for manual review include addressing flight interactions or combinations. As mentioned previously, millions of “flights” may be executing simultaneously, which results in hundreds of flight combinations for analysis. For example, there are 2^{k} possible flight combinations for “k” features that are independently on or off in all possible combinations. Another example of a nuanced layout anomaly may involve the robustness of bi-directional language. Some languages are written from right to left, rather than the traditional Western format of left to right. How these languages are displayed on a webpage and what potential anomalies may arise from translating a webpage from a left-to-right language to a right-to-left language may be captured by these machine-learning algorithms and subsequently analyzed, organized, and transmitted for further review.

The transmission of the collected corrective action data in operation 218 may be reported back to developer teams and other individuals for manual review, so that the source code behind the webpages may be manually scrutinized and updated appropriately. In some example aspects, the anomalies that are targeted by the collected corrective action data in operation 218 may be automatically corrected in subsequent iterations, as the datasets powering the machine-learning algorithms continue to increase in size. As the datasets increase in the size, the intelligence of the machine-learning algorithms may continue to increase, which may result in the automatic correction of anomalies that previously would have required manual correction. The patterns that were extracted from the machine-learning algorithms (e.g., both context and layout data) may be indicative of millions or even billions of webpage layout anomalies and interaction data among various flights. These patterns may be aggregated and formatted appropriately during the transmission operation 218, so that the data may be human-readable and may be acted upon by a developer or teams of developers. Aggregating and formatting corrective action data for millions or billions of webpage data and various permutations of flight interactions is humanly impossible.

In conjunction with the transmit corrective action data operation 218, the corrective action that was determined in operation 210 may actually be applied to the webpage or application in operation 212. At apply corrective action operation 212, system 200 may fix the detected anomaly on the webpage, application or other entity plagued with the anomaly. For instance, apply corrective action operation 212 may result in the actual removal of an overlapping image or element from a webpage following the determination in operation 210 that the appropriate corrective action to apply in such an instance would be to remove an overlapping image or element. In other examples, if a certain image failed to render completely, apply corrective action operation 212 may result in a refresh operation for the webpage. In yet other examples, the apply corrective action operation 212 may downgrade the graphic features of a webpage or application in order to ensure that certain content or a certain image may be able to fully render on the webpage or application.

As discussed previously, system 200 may be executed automatically, from initial detection of operating environment characteristics at operation 204 to apply the corrective action operation 212. Furthermore, system 200 is capable of handling multiple anomalies across numerous networks and operating environments. Because system 200 may be run in a distributed environment on multiple servers, system 200 can substantially simultaneously correct numerous anomalies occurring on a variety of devices with different hardware and software configurations.

As should be appreciated, the various methods, devices, components, etc., described with respect to FIG. 2 are not intended to limit systems 200 to being performed by the particular components described. Accordingly, additional topology configurations may be used to practice the methods and systems herein and/or components described may be excluded without departing from the methods and systems disclosed herein.

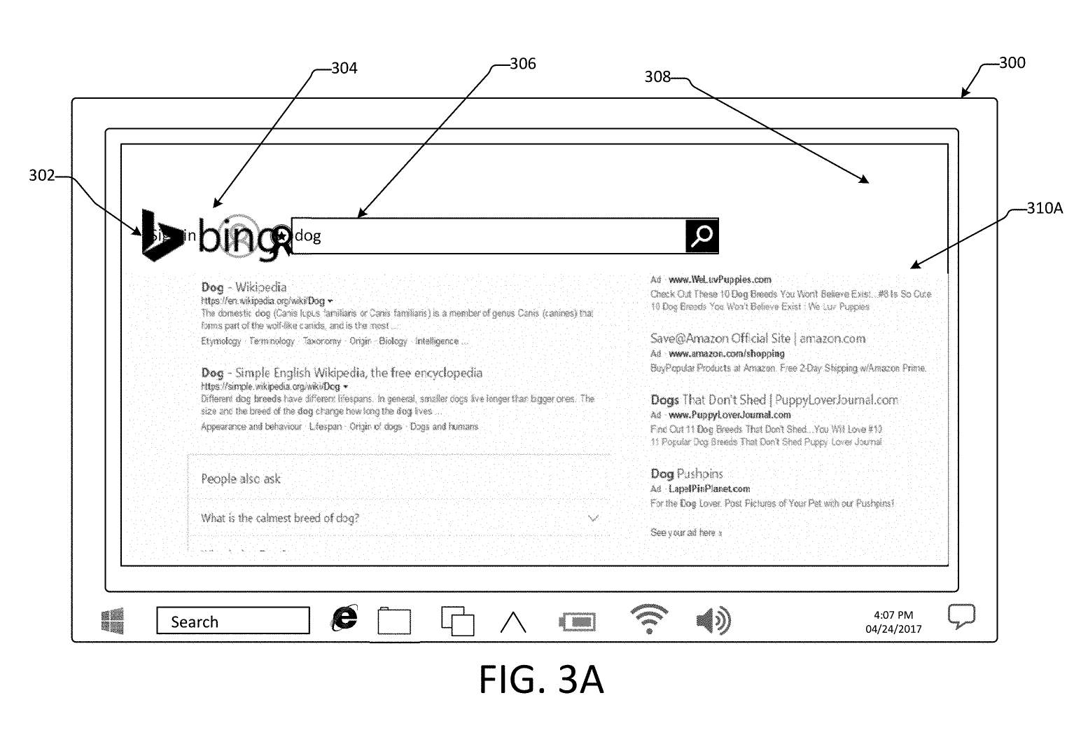

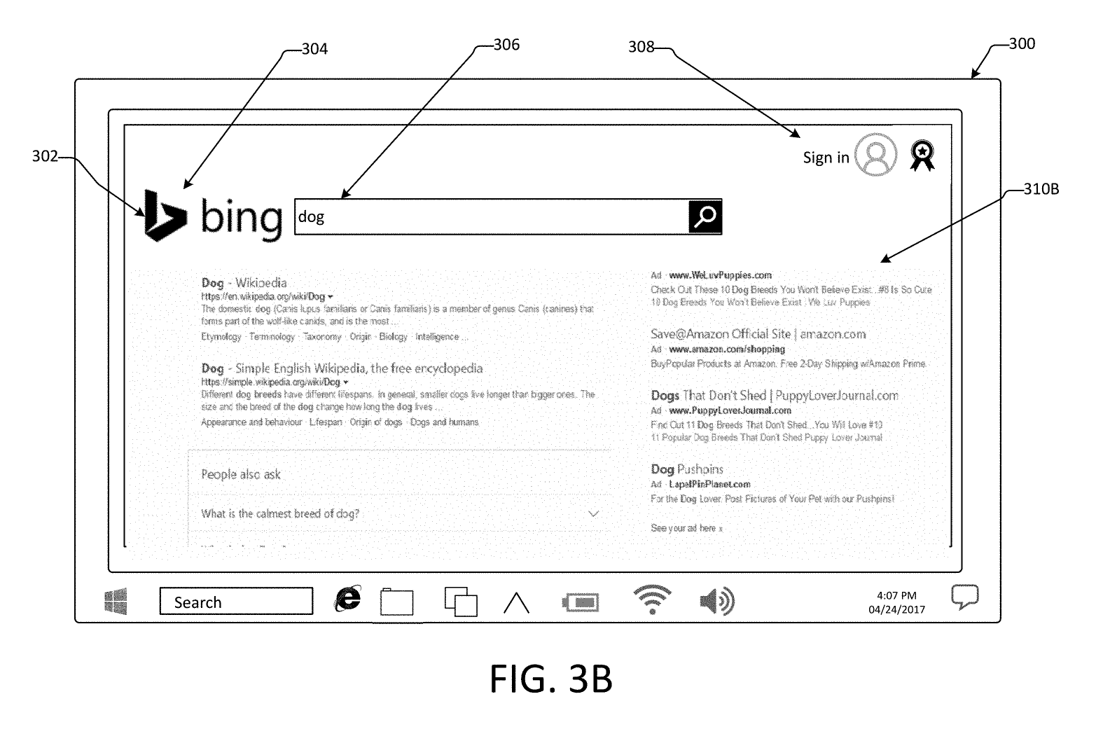

FIG. 3A illustrates an example of a broken webpage 310A with one or more layout anomalies. As depicted, a personal computer 300 is displaying the webpage 310A, specifically the Bing® search engine webpage. In one example aspect, the Bing® logo 302 may be positioned to the left side of the search bar 306. A dataset of correct layouts of the Bing® search webpage may be stored in a database that may be accessed by the system disclosed herein. Upon referencing datasets of correct layouts, it may be determined that the Bing® logo 302 alone should be displayed in area 304. However, as depicted, a layout anomaly has caused the Bing® logo 302 to overlap other images/elements within area 304. The images/elements that are depicted in webpage 310A include a logo and text associated with user Sign In elements. According to the dataset of correct Bing® webpage layouts, the Sign In elements should be located in area 308, where no images/elements are currently displayed. As described in detail in FIG. 2, the system disclosed herein may detect the layout anomaly that is depicted in FIG. 3A and determine an appropriate corrective action to address the detected anomaly.

FIG. 3B illustrates an example of a corrected webpage 310B displayed on personal computer 300. After the system detected the layout anomaly that was depicted in FIG. 3A and determined an appropriate corrective action to apply to the layout anomaly, the corrective action may be applied to the webpage 310A. As illustrated by FIG. 3B, the Bing® logo 302 is no longer overlapping any images/elements in area 304, and the Sign In elements have been repositioned to their correct location in area 308 based on the analyzed datasets of correct Bing® webpage layouts. The system disclosed herein may detect the overlapping image/element anomaly, compare the layout anomaly and the operating environment characteristics with previously stored data, determine an appropriate corrective action to apply, and apply the determined corrective action automatically. A more detailed description of the automatic system disclosed herein may be found in FIG. 2.

As should be appreciated, the various methods, devices, components, etc., described with respect to FIGS. 3A and 3B are not intended to limit systems 300 to being performed by the particular components described. Accordingly, additional topology configurations may be used to practice the methods and systems herein and/or components described may be excluded without departing from the methods and systems disclosed herein.

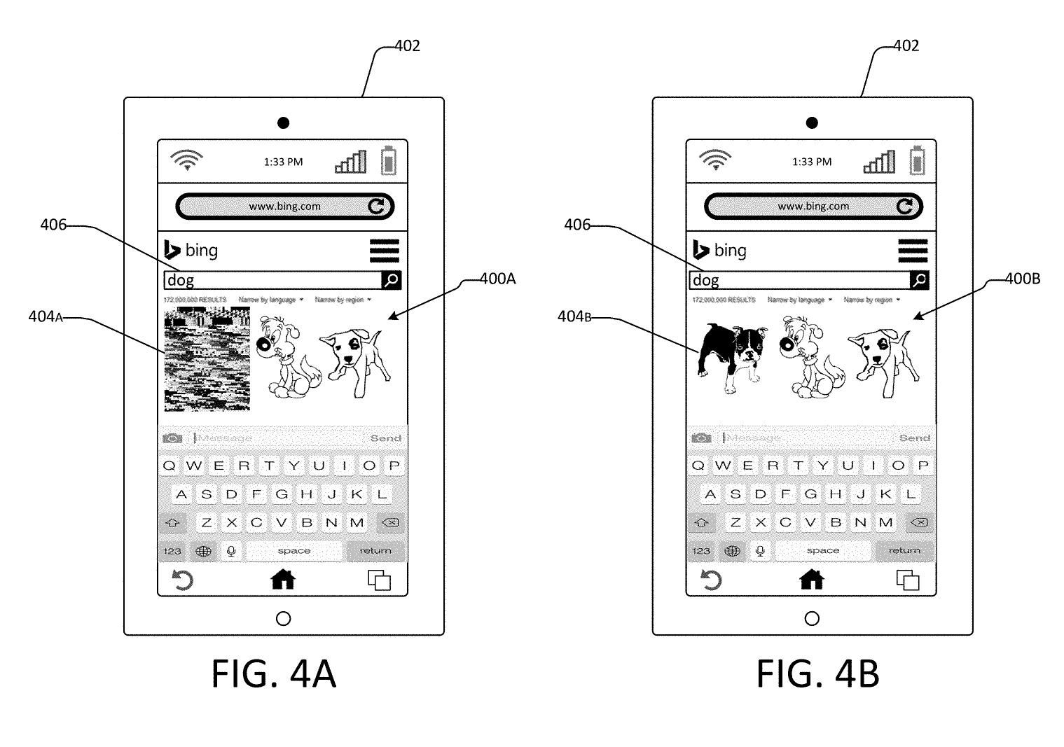

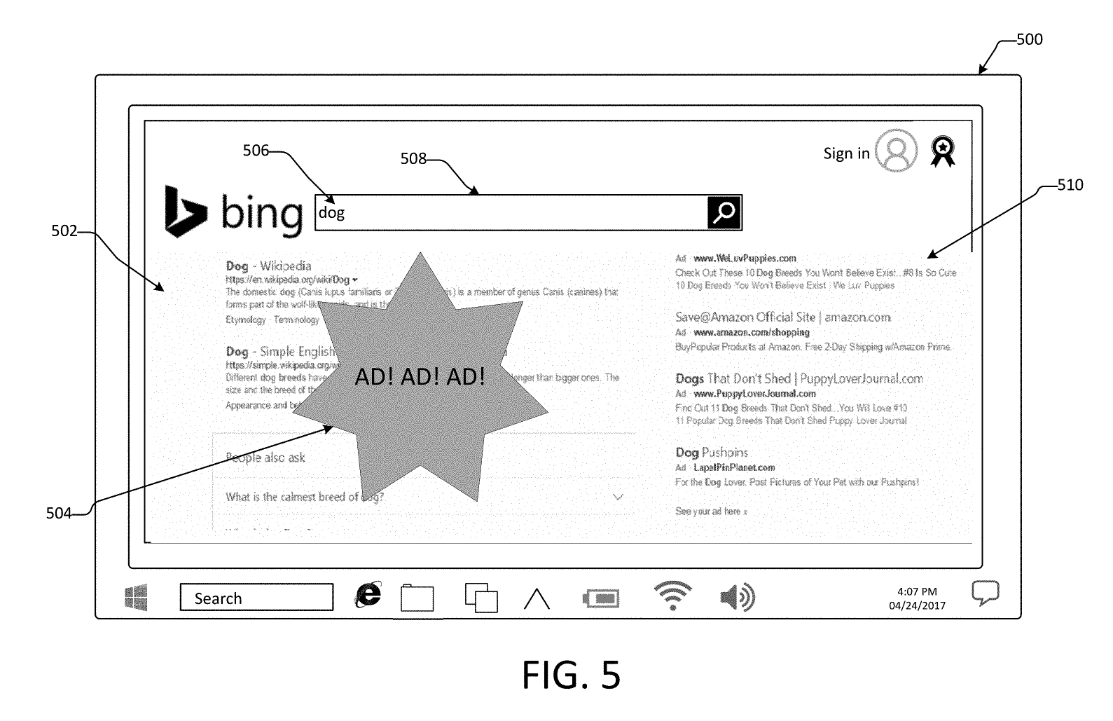

FIG. 4A illustrates an example of a mobile webpage 400A with layout anomalies. The layout anomaly depicted in FIG. 4A is a failed image rendering anomaly on a mobile device 402. A Bing® image search for “dog” in search bar 406 has produced two of three images, but image 404A has failed to render properly. In this case, rather than evaluating a dataset, the system may detect that image 404A rendered improperly based on evaluating pixels rendered on the display surface of mobile device 402. For instance, pixels associated with image 404A may not correspond with expected pixels representing an image. In some cases, the pixels may be evaluated automatically by an algorithm designed to identify inconsistencies and breaks in the pixels of a rendered image (e.g., incomplete page rendering, overlapping page areas). In one instance, the layout for a page may be captured as pixels. Thereafter, the distance between pixels on a partial or entire webpage or application area may be compared to the layout, which may then be used to determine whether anomalies exist within the partial or entire webpage or application that was analyzed. In yet another instance, the transferred bytes of an image may be analyzed and used to detect anomalies. For example, a transferred byte size of an image may be larger or smaller than the expected byte size. In response to detecting the anomaly (e.g., an improperly rendered image), the system disclosed herein may determine an appropriate corrective action corresponding to an improperly rendered image. For instance, the system may reference a dataset of corrective actions corresponding to improperly rendered images, e.g., refreshing the page, downgrading graphics, deleting or hiding the improperly rendered image.

FIG. 4B illustrates an example of a corrected mobile webpage 400B. As discussed above, after the system disclosed herein has detected the layout anomaly (failed image rendering in FIG. 4A), the system may determine a corrective action based on pre-programmed corrective actions and/or previously stored data related to corrective actions that have been applied to similar device configurations and anomaly characteristics. As illustrated by FIG. 4B, a corrective action has been applied to the mobile Bing® webpage 400A, and as a result, image 404B has now been fully rendered on the mobile Bing® webpage 400B.

As previously discussed, a variety of corrective actions may have been applied to repair the broken image 404A. For example, if it was detected that the initial network connection between the content-hosting server and the mobile device 402 had been interrupted, the corrective action may involve simply refreshing the page or one or more parts of the page. In other example aspects, if it was detected that the local memory, CPU, and/or GPU of mobile device 402 was ill equipped to retrieve and display the webpage, the corrective action may have involved downgrading the graphics and quality of downloaded content.

As should be appreciated, the various methods, devices, components, etc., described with respect to FIGS. 4A and 4B are not intended to limit systems 400 to being performed by the particular components described. Accordingly, additional topology configurations may be used to practice the methods and systems herein and/or components described may be excluded without departing from the methods and systems disclosed herein.

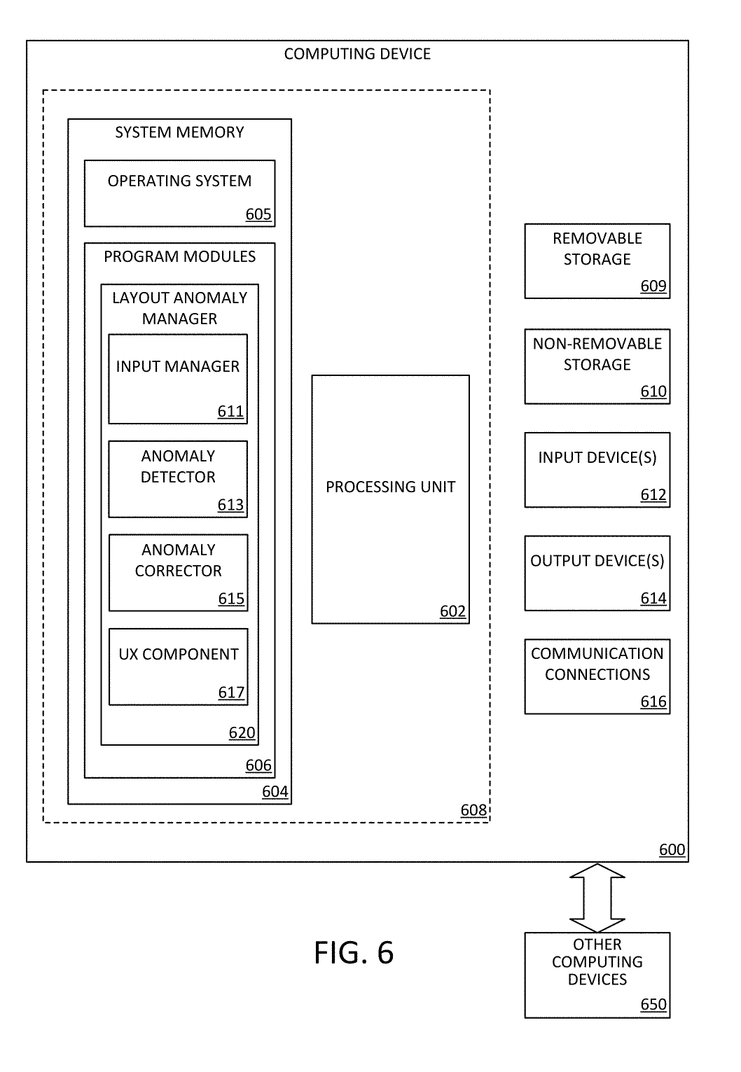

FIG. 5 illustrates an example of a webpage 510 displayed on a computing device 500 (e.g., a tablet computing device) with layout anomalies caused by a third-party application or extension. For instance, the layout anomaly depicted in FIG. 5 may be a pop-up advertisement from a third-party extension or application running within the browser. As illustrated, pop-up advertisement 504 is covering content 502. Content 502 is content that has been generated based on a search term 506 received in search bar 508 on the Bing® search webpage. However, because the third-party pop-up advertisement 504 has prevented content 502 from displaying, the system disclosed herein may consider the third-party pop-up advertisement 504 a layout anomaly that calls for corrective action. In some example aspects, the corrective action that may be applied to the webpage may be to reposition pop-up advertisement 504 to another location that does not cover content 502. In other example aspects, the corrective action that may be applied may be to delete or hide pop-up advertisement 504 on the webpage.

In other example aspects, a third-party application or extension may run an ad-blocker on a webpage. In such a scenario, content that is intended to be displayed on a webpage may be obscured from view. Such obfuscation of content that is intended to be displayed on a webpage may be considered a layout anomaly. A corrective action that may be applied in such an instance may be to remove the ad blocker extension, or alternatively, the corrective action may be to reposition the covered content to a different location on the webpage where the ad blocker may be unable to cover the content. A variety of appropriate corrective actions may be determined according to the operating environment characteristics of the device (e.g., dimensions of display) and the characteristics of the detected layout anomaly. A single corrective action or multiple corrective actions from the variety of determined appropriate corrective actions may be applied to the webpage in order to remove the layout anomaly.

As should be appreciated, the various methods, devices, components, etc., described with respect to FIG. 5 is not intended to limit systems 500 to being performed by the particular components described. Accordingly, additional topology configurations may be used to practice the methods and systems herein and/or components described may be excluded without departing from the methods and systems disclosed herein.

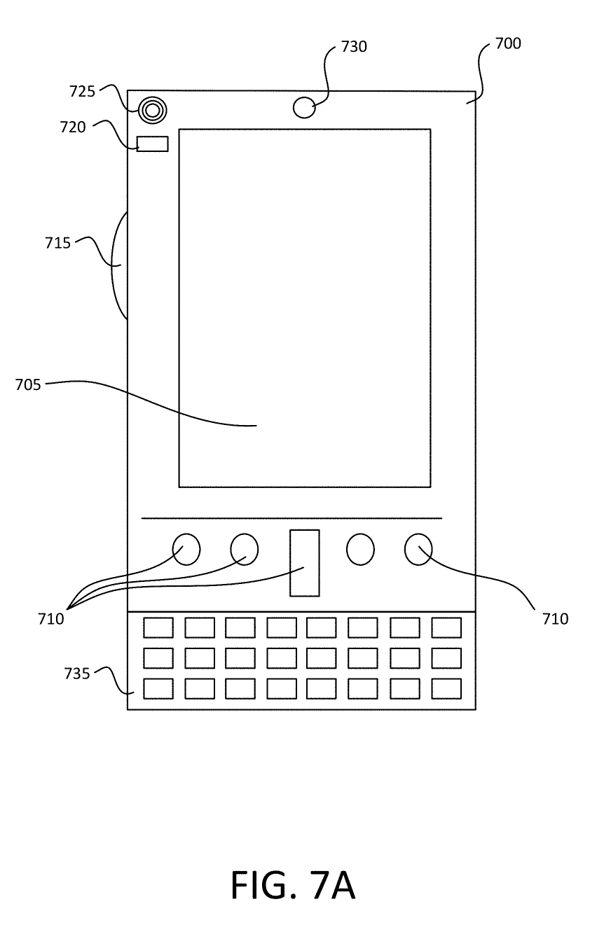

FIGS. 6-9 and the associated descriptions provide a discussion of a variety of operating environments in which aspects of the disclosure may be practiced. However, the devices and systems illustrated and discussed with respect to FIGS. 6-9 are for purposes of example and illustration and are not limiting of a vast number of computing device configurations that may be utilized for practicing aspects of the disclosure, as described herein.

FIG. 6 is a block diagram illustrating example physical components (e.g., hardware) of a computing device 600 with which aspects of the disclosure may be practiced. The computing device components described below may have computer-executable instructions for implementing a layout anomaly manager 620 on a computing device (e.g., server computing device and/or client computing device). The computer-executable instructions for a layout anomaly manager 620 can be executed to implement the methods disclosed herein, including a method of automatically detecting a layout anomaly and providing an appropriate corrective action to remove the detected layout anomaly. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running a layout anomaly manager 620, such as one or more components with regard to FIG. 1 and, in particular, an input manager 611, an anomaly detector 613, an anomaly corrector 615, and/or UX Component 617.

The operating system 605, for example, may be suitable for controlling the operation of the computing device 600. Furthermore, embodiments of the disclosure may be practiced in conjunction with a graphics library, a UI Framework, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., layout anomaly manager 620) may perform processes including, but not limited to, the aspects, as described herein. Other program modules that may be used in accordance with aspects of the present disclosure, and in particular for automatically detecting a layout anomaly and providing an appropriate corrective action to remove the detected layout anomaly, may include an input manager 611, an anomaly detector 613, an anomaly corrector 615, and/or UX Component 617, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include tangible storage media such as RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such tangible computer storage media may be part of the computing device 800. Computer storage media may be non-transitory media that does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

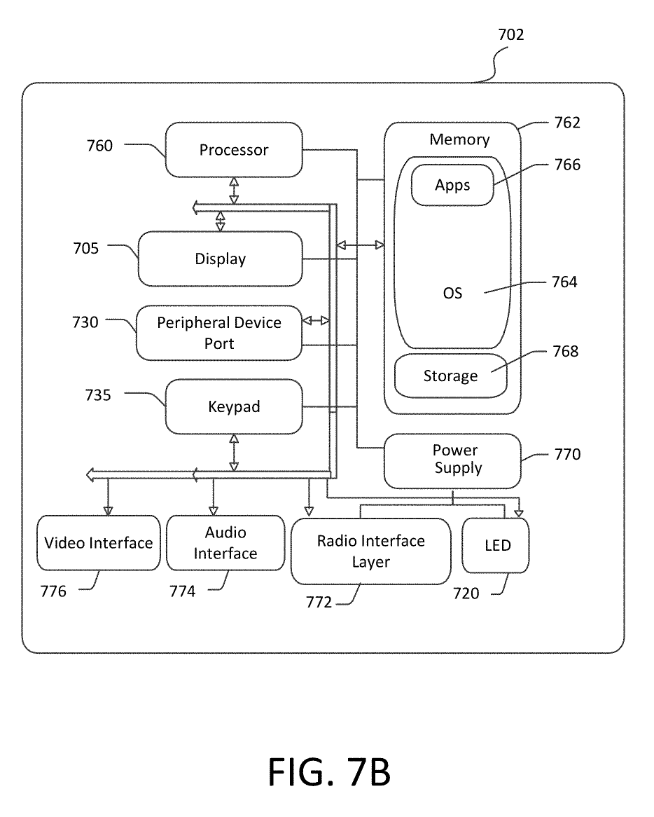

FIGS. 7A and 7B illustrate a mobile computing device 700, for example, a mobile telephone, a smart phone, wearable computer (such as a smart watch or head-mounted display for virtual reality applications), a tablet computer, a laptop computer, and the like, with which embodiments of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as email or other messages used by an email application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the instructions for automatically detecting a layout anomaly and providing an appropriate corrective action to remove the detected layout anomaly as described herein (e.g., input manager 611, anomaly detector 613, anomaly corrector 615, and/or UX Component 617, etc.).

The system 702 has a power supply 770, which may be implemented as one or more batteries. The power supply 770 may further include an external power source, such as an AC adapter or a powered docking cradle that supplements or recharges the batteries. The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via an audio transducer 725 (e.g., audio transducer 725 illustrated in FIG. 7A). In the illustrated embodiment, the visual indicator 720 is a light emitting diode (LED) and the audio transducer 725 may be a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of peripheral device 730 (e.g., on-board camera) to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

As should be appreciated, FIGS. 7A and 7B are described for purposes of illustrating the present methods and systems and are not intended to limit the disclosure to a particular sequence of steps or a particular combination of hardware or software components.

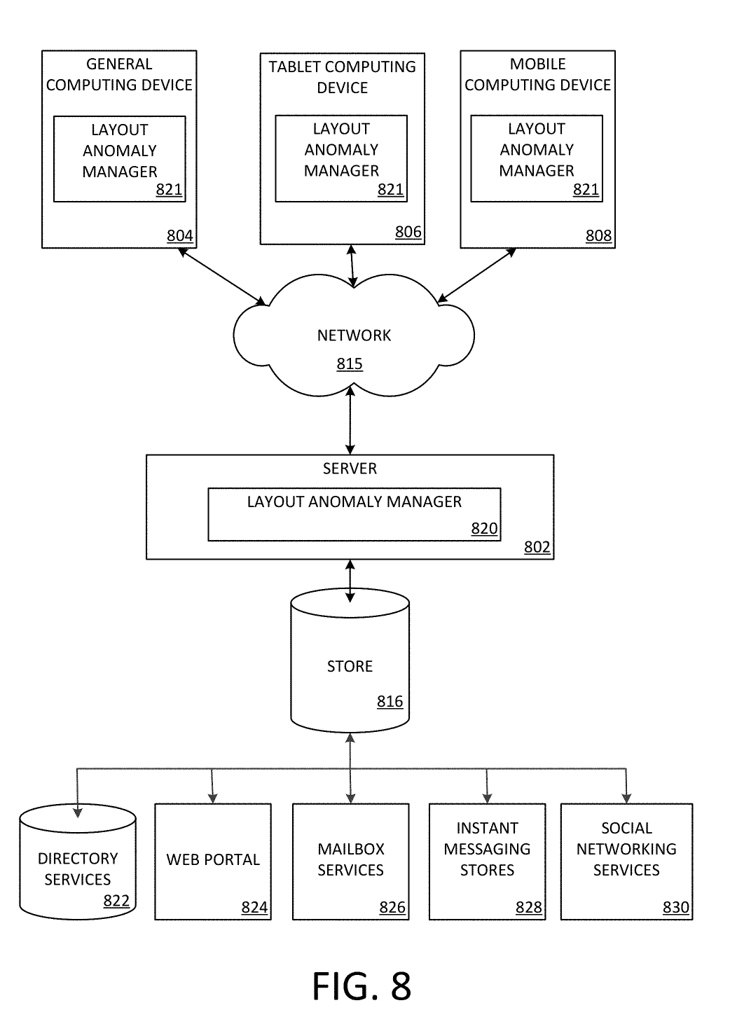

FIG. 8 illustrates one aspect of the architecture of a system for processing data received at a computing system from a remote source, such as a general computing device 804 (e.g., personal computer), tablet computing device 806, or mobile computing device 808, as described above. Content displayed at server device 802 may be stored in different communication channels or other storage types. For example, various documents may be stored using a directory service 822, a web portal 824, a mailbox service 826, an instant messaging store 828, or a social networking service 830. The layout anomaly manager 821 may be employed by a client that communicates with server device 802, and/or the layout anomaly manager 820 may be employed by server device 802. The server device 802 may provide data to and from a client computing device such as a general computing device 804, a tablet computing device 806 and/or a mobile computing device 808 (e.g., a smart phone) through a network 815. By way of example, the computer system described above with respect to FIGS. 1-7 may be embodied in a general computing device 804 (e.g., personal computer), a tablet computing device 806 and/or a mobile computing device 808 (e.g., a smart phone). Any of these embodiments of the computing devices may obtain content from the store 816, in addition to receiving graphical data useable to either be pre-processed at a graphic-originating system or post-processed at a receiving computing system.

As should be appreciated, FIG. 8 is described for purposes of illustrating the present methods and systems and is not intended to limit the disclosure to a particular sequence of steps or a particular combination of hardware or software components.

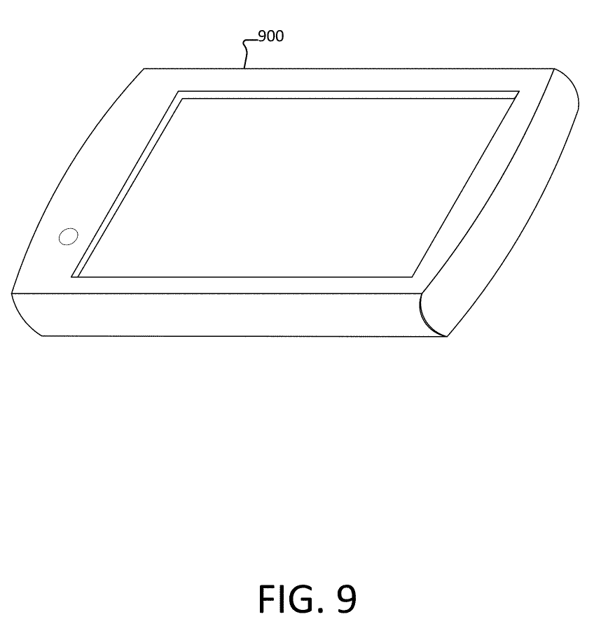

FIG. 9 illustrates an exemplary tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As should be appreciated, FIG. 9 is described for purposes of illustrating the present methods and systems and is not intended to limit the disclosure to a particular sequence of steps or a particular combination of hardware or software components.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

1. A processor-implemented method of correcting layout anomalies, comprising:
detecting at least one operating environment characteristic of a computing device;
detecting at least one layout anomaly on a display interface of the computing device;
characterizing the at least one layout anomaly by comparing the at least one layout anomaly to historical anomaly data and proper configuration data;
determining at least one corrective action corresponding to the at least one layout anomaly based on the characterizing;
automatically applying the at least one corrective action corresponding to the at least one layout anomaly; and
updating a database with the at least one operating environment characteristic, the at least one layout anomaly, and the at least one corrective action.

2. The method of claim 1, wherein determining the at least one corrective action is based at least in part on identifying a corrective action corresponding to a previous layout anomaly.

3. The method of claim 2, wherein the at least one previous layout anomaly was retrieved from the database.

4. The method of claim 2, wherein the corrective action corresponding to the previous layout anomaly was retrieved from the database.

5. The method of claim 4, wherein the previous layout anomaly and the corresponding corrective action are associated with a previous operating environment characteristic that is consistent with the at least one operating environment characteristic.

6. The method of claim 1, wherein the database is associated with a machine-learning algorithm.

7. The method of claim 1, wherein the at least one operating environment characteristic includes at least one of: device type, screen dimension, screen resolution, operating system type, operating system version, Internet browser type, Internet browser version, RAM size, and local storage size.

8. The method of claim 1, wherein the at least one layout anomaly includes at least two overlapping elements on the display interface.

9. The method of claim 1, wherein characterizing the at least one layout anomaly is based at least in part on at least one priority display ranking.

10. The method of claim 1, wherein the at least one layout anomaly includes at least one image that failed to fully render.

11. The method of claim 1, wherein characterizing the at least one layout anomaly further comprises:
detecting at least one pattern based in part on at least one related, previous layout anomaly, wherein the at least one corrective action is based on the at least one pattern.

12. The method of claim 1, wherein the at least one layout anomaly is associated with at least one third-party application.

13. The method of claim 12, wherein the at least one layout anomaly includes at least one element generated by the at least one third-party application, wherein the at least one element modifies at least a portion of content on the device interface of the computing device.

14. The method of claim 13, wherein determining at least one corrective action corresponding to the at least one layout anomaly further comprises:
determining at least one location on the device interface, wherein the at least one location on the device interface does not obscure the at least one portion of content.

15. The method of claim 14, wherein applying the at least one corrective action further comprises:
repositioning the at least one element generated by the at least one third-party application to the at least one location on the device interface.

16. The method of claim 1, wherein determining the at least one corrective action includes modifying at least one technical requirement of a portion of content for display on the display interface.

17. A computing device comprising:
at least one processing unit;
at least one memory storing processor-executable instructions that when executed by the at least one processing unit cause the computing device to:
detect operating environment characteristics of the computing device;
detect at least one layout anomaly on a display interface of the computing device based on the operating environment characteristics;
filter down the operating environment characteristics to form filtered characteristics;
characterize the at least one layout anomaly based at least in part on a previous layout anomaly, proper configuration data, and the filtered characteristics;
determine at least one corrective action corresponding to the at least one layout anomaly based on the characterization of the at least one layout anomaly;
automatically apply the at least one corrective action corresponding to the at least one layout anomaly; and
update a database with the at least one operating environment characteristic, the at least one layout anomaly, and the at least one corrective action.

18. The computing device of claim 17, wherein the at least one layout anomaly is an at least one unknown layout anomaly according to the at least one machine-learning database.

19. The computing device of claim 17, wherein determining at least one corrective action associated with the at least one unknown layout anomaly includes manual analysis.

20. A processor-readable storage medium not consisting of a modulated data signal and storing instructions for executing on one or more processors of a computing device a method of correcting layout anomalies, the method comprising:
detecting at least one operating environment characteristic of the computing device;
detecting at least one layout anomaly on a display interface of the computing device;
characterizing the at least one layout anomaly into an anomaly type based at least in part on a previous layout anomaly and to proper configuration data;
determining at least one corrective action corresponding to the anomaly type;
automatically applying the at least one corrective action corresponding to the anomaly type; and
updating a database with the at least one operating environment characteristic, the at least one layout anomaly, and the at least one corrective action.
